(19) United States
(12) Patent Application Publication
(10) Pub. No.: US 2012/0312462 A1
(43) Pub. Date: Dec. 13, 2012

(54) METHOD AND SYSTEM FOR MANUFACTURING LIQUID CRYSTAL DISPLAY DEVICE

(75) Inventors: Satoshi Hirata, Osaka (JP); Seiji Kondo, Osaka (JP)

(73) Assignee: NITTO DENKO CORPORATION, Osaka (JP)

(21) Appl. No.: 13/487,525

(22) Filed: Jun. 4, 2012

(30) Foreign Application Priority Data
Jun. 8, 2011 (JP) 2011-128174

(51) Int. Cl. B32B 37/20; B32B 37/12

(52) U.S. Cl. 156/235; 156/540

(57) ABSTRACT

Provided are a method and a system for manufacturing a liquid crystal display device, which can reduce warping of a liquid crystal panel by bonding optical films alternately to the first and second panel surfaces of the liquid crystal panel, in which the method includes: feeding carrier films from continuous rolls, respectively; and bonding steps including bonding optical films, which are peeled off or being peeled off from the carrier films, to the first and second panel surfaces of a liquid crystal panel, respectively, wherein in the bonding steps, bonding the optical film to the first panel surface of the liquid crystal panel and bonding the optical film to the second panel surface of the liquid crystal panel are performed alternately.

### BACKGROUND OF THE INVENTION

1. Field of the Invention

The invention relates to a method and a system for manufacturing a liquid crystal display device.

2. Description of the Related Art

A conventional process of laminating optical films to a liquid crystal panel includes cutting an optical film into pieces and bonding a cut piece of the optical film (a sheet piece) to the liquid crystal panel. In such a bonding process, very low and stable tension can be applied to the optical film, and therefore, the liquid crystal panel is less likely to be warped due to variations in tension or over-tension after the bonding. In recent years, a bonding apparatus capable of simultaneously bonding pieces of optical film to both sides of a liquid crystal panel have been developed, which makes it easy to provide more uniform bonded states on the front and back sides in the bonding process.

On the other hand, a process is known which includes drawing a carrier film from a continuous roll, which is a roll of a laminate including the carrier film and an optical film placed thereon, peeling off the optical film from the carrier film, and bonding the optical film to a liquid crystal panel (hereinafter referred to as a “roll bonding process”) (see Japanese Patent Application Laid-Open (JP-A) No. 2005-37417).

Japanese Patent Application Laid-Open (JP-A) No. 2005-37417.

### SUMMARY OF THE INVENTION

The roll bonding process includes folding back the carrier film at the front end of a peeling unit so that the optical film (carrying the pressure-sensitive adhesive) is directly bonded to the liquid crystal panel while being peeled off from the carrier film.

In the roll bonding process, the optical film is bonded to the liquid crystal panel while a tension associated with the feeding is applied to the optical film, so that the shrinking force of the optical film is presented in the liquid crystal panel with the optical film bonded thereto, and in response to this, the liquid crystal panel may be warped. In such a case, the liquid crystal panel is warped concave with the optical film-bonded surface inside. In some cases, there is also a difference in the number of times of bonding of the optical film between the first and second panel surfaces (for example, the viewer side and the back side) of the liquid crystal panel. For example, a polarizing film is bonded to the viewer side, and a polarizing film and a retardation film are successively bonded to the back side (namely, a single optical film is bonded to the viewer side, and two optical films are successively bonded to the back side). In such a case, the successive bonding to the back side increases the shrinking force generated on the back side, so that the shrinking forces on the first and second panel surfaces of the liquid crystal panel become out of balance, which changes the amount of warping. Therefore, if more optical films are bonded to one panel surface of a liquid crystal panel in an unbalanced manner, the liquid crystal panel will be warped significantly, so that the end of the liquid crystal panel may come into contact with a feed roller during the feeding of the panel, which may cause problems such as formation of cullet, unstable feeding, and liquid crystal panel meandering.

Also, if the liquid crystal panel is significantly warped to the viewer side, for example, to become too bowl-shaped, the feeding of the liquid crystal panel will be unstable so that it will be difficult to make adjustment of the position (alignment) in the bonding process.

Thus, the invention, which has been accomplished in view of the above circumstances, provides a method and a system for manufacturing a liquid crystal display device, which can reduce warping of a liquid crystal panel by bonding optical films alternately to the first and second panel surfaces of the liquid crystal panel.

The invention is directed to a method for manufacturing a liquid crystal display device, including: feeding long carrier films from continuous rolls, respectively, wherein the continuous rolls include rolls of laminates including the long carrier films and pressure-sensitive adhesive-carrying optical films each with a specific width placed on the carrier films; and bonding steps including bonding the optical films, which are peeled off or being peeled off from the carrier films, to first and second panel surfaces of a liquid crystal panel, respectively, wherein in the bonding steps, bonding the optical film to the first panel surface of the liquid crystal panel and bonding the optical film to the second panel surface of the liquid crystal panel are performed alternately.

According to this feature, optical films are bonded alternately to the first and second panel surfaces of a liquid crystal panel, which can reduce warping of the liquid crystal panel, stabilize the feeding of the panel to prevent the formation of cullet, and prevent misalignment at the bonding position so that bonding misalignment can be prevented.

The invention is also directed to a system for manufacturing a liquid crystal display device, which is configured to feed long carrier films from continuous rolls, respectively, wherein the continuous rolls include rolls of laminates including the long carrier films and pressure-sensitive adhesive-carrying optical films each with a specific width placed on the carrier films, and which includes a bonding apparatus for bonding the optical films, which are peeled off or being peeled off from the carrier films, to first and second panel surfaces of a liquid crystal panel, respectively, wherein the bonding apparatus includes a plurality of bonding units so that it alternately performs bonding the optical film to the first panel surface of the liquid crystal panel and bonding the optical film to the second panel surface of the liquid crystal panel.

According to this feature, optical films are bonded alternately to the first and second panel surfaces of a liquid crystal panel, which can reduce warping of the liquid crystal panel, stabilize the feeding of the panel to prevent the formation of cullet, and prevent misalignment at the bonding position so that bonding misalignment can be prevented.

Hereinafter, a mechanism of how a liquid crystal panel is warped will be described with reference to FIGS. 1 and 2A and 2B. As shown in FIG. 1, a liquid crystal panel is warped when stress is generated in an optical film by the tension (tensile force along the bonding direction) applied to the optical film in the process of bonding the optical film to the liquid crystal panel and the liquid crystal panel follows a pressure-sensitive adhesive in response to the stress. In addition, as shown in FIG. 2B, when two optical films are successively bonded to one surface of the liquid crystal panel, the shrinking force generated on the one surface is increased, so that the warping becomes larger than that shown in FIG. 2A where a single optical film is bonded. For example, if a second optical film is bonded to the first panel surface of the liquid crystal panel warped by the bonding of the first optical film to the first panel surface, the shrinking stresses in the first and second optical films will cause the liquid crystal panel to be more significantly warped concave (bowl-shaped) with the first panel surface inside (see FIG. 2B). In contrast, if the second optical film is bonded to the second panel surface and if the shrinking stress in the second optical film is higher than that in the first optical film, the panel will be warped concave with the second panel surface inside, which is in a direction reverse to that mentioned above. If the shrinking stress in the second optical film is the same as that in the first optical film, the stresses will cancel out each other to eliminate warping. Therefore, in order to suppress the warping of the liquid crystal panel most effectively during the feeding of the panel and after the completion of the bonding of the optical films, it is important to bond the optical films alternately to the first and second panel surfaces.

The tension applied to the optical film during bonding should be at least a tension necessary for the feeding of the carrier film. For example, the tension necessary for the feeding of the carrier film is in the range of 5 to 20 [N/10 cm]. If a tension higher than the above is applied to the carrier film, the optical film may also be stretched together with the carrier film, which may cause a change in the optical properties or breakage of the carrier film or the optical film.

For example, the tension applied to the optical film during bonding is in the range of 3 to 30 [N/10 cm]. If this tension is too low, the film may slack, so that bubbles or bonding misalignment may occur. On the other hand, if the tension is too high, bonding misalignment will occur.

### BRIEF DESCRIPTION OF THE DRAWINGS

FIG. 1 is a diagram for illustrating how a liquid crystal panel is warped;

FIGS. 2A and 2B are diagrams for illustrating the amount of warping depending on the times of bonding of optical films;

FIG. 3 is a flow chart of a method for manufacturing a liquid crystal display device;

FIG. 4 is a diagram for illustrating a system for manufacturing a liquid crystal display device;

FIG. 5 is a diagram for illustrating a method for measuring the amount of bonding misalignment; and

FIG. 6 is a diagram for illustrating a method for measuring the amount of warping.

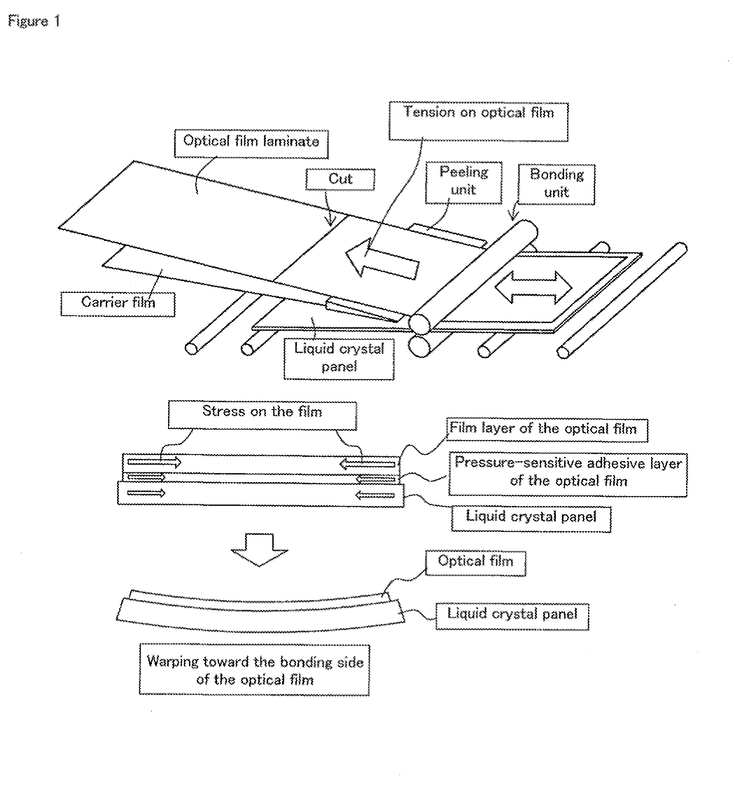

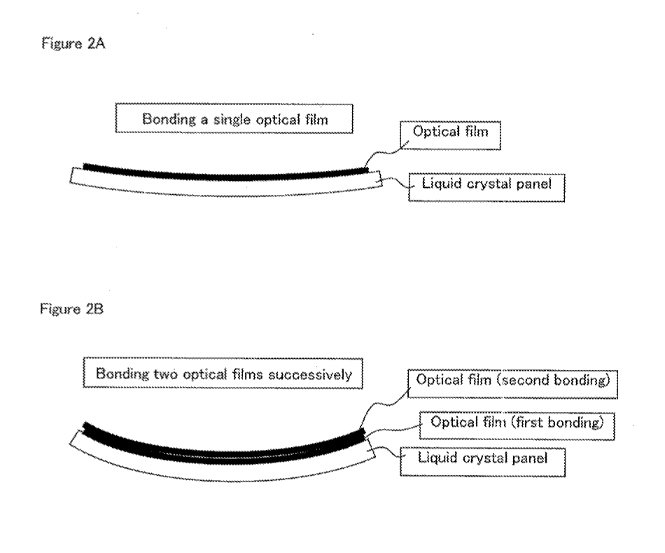

### DETAILED DESCRIPTION OF THE PREFERRED EMBODIMENTS

Each optical film may be of any type having a pressure-sensitive adhesive layer as an outermost layer, and it may be a monolayer structure or a multilayer structure. For example, each optical film may be a plastic film with a thickness of about 50 to about 200 μm. The elastic modulus of the optical film can be determined by the measurement method described below. The film is cut into a strip shape with a width of 10 mm and a length of 100 mm. In the measurement under a 25° C. temperature environment, the strip-shaped sample is pulled in the longitudinal direction under the conditions below using a universal tensile/compression tester (Tensilon). The resulting S-S (Stress-Strain) curve is used to determine the tensile elastic modulus. The measurement is performed under the conditions of a tension rate of 50 mm/minute, a chuck-chuck distance of 50 mm, and room temperature. The elastic modulus is determined from the S-S curve by a method including drawing a tangent line from the initial rise point of the S-S curve, reading the strength at the point where an extension of the tangent line reaches 100% strain, and dividing the read value by the cross-sectional area of the sample strip (thickness x sample width (100 mm)) so that the quotient is used as the vertical (tensile) elastic modulus. For example, the vertical (tensile) elastic modulus of the optical film may be from about 0.5 to about 7.0 [GPa].

For example, the optical film may be a polarizer or a polarizing film, and the polarizing film may have a structure including a polarizer and a polarizer-protecting film or films placed on one or both sides of the polarizer. A surface protecting film or films may also be placed thereon to protect the polarizer or the polarizing film from scratches and others during transportation. Other examples of the optical film include optical compensation films such as retardation films and brightness enhancement films. The multilayer-structure optical film may include a polarizer or a polarizing film and a retardation film and/or a brightness enhancement film placed on the polarizer or polarizing film. Hereinafter, the term “MD polarizing film” refers to an elongated polarizing film having an absorption axis in the longitudinal direction, in which the polarizer has an absorption axis in the stretched direction, and the term “TD polarizing film” refers to an elongated polarizing film having an absorption axis in the transverse direction (widthwise direction).

For example, the polarizing film may be a dichroic polarizing film. The dichroic polarizing film may be manufactured by a process including the steps of (A) dyeing, crosslinking, stretching, and drying a polyvinyl alcohol-based film to obtain a polarizer; (B) bonding a protecting layer or layers to one or both sides of the polarizer; and (C) heat-treating the resulting laminate. Dyeing, crosslinking, and stretching of the polyvinyl alcohol-based film do not have to be each independently performed, and may be performed simultaneously, or they may be performed in any order. It will be understood that a polyvinyl alcohol-based film having undergone a swelling treatment may also be used as the polyvinyl alcohol-based film. In general, the polyvinyl alcohol-based film is immersed in a solution containing iodine or a dichroic dye so that the film is dyed with the adsorbed iodine or dichroic dye, then cleaned, uniaxially stretched to a stretch ratio of 3 to 7 in a solution containing boric acid or borax and other additives, and then dried.

For example, the brightness enhancement film may be a reflective polarizing film having a multilayer structure with a reflection axis and a transmission axis. For example, the reflective polarizing film can be obtained by alternately stacking a plurality of polymer films A and B made of two different materials and stretching them. The refractive index of only the material A is changed and increased in the stretching direction, so that birefringence is produced, in which a reflection axis is formed in the stretching direction where there is a difference in refractive index at the material A-B interface, and a transmission axis is formed in the direction (non-stretching direction) where no difference in refractive index is produced. This reflective polarizing film has a transmission axis in the longitudinal direction and an absorption axis in the transverse direction (widthwise direction).

The pressure-sensitive adhesive in the outermost layer of the optical film is typically, but not limited to, an acrylic pressure-sensitive adhesive, a silicone-based pressure-sensitive adhesive, a urethane-based pressure-sensitive dhesive, or the like. For example, a plastic film (such as a polyethylene terephthalate-based film or a polyolefin-based film) or any other film may be used to form the carrier film. Any appropriate film such as a film coated with an appropriate release agent such as a silicone, long-chain alkyl, or fluoride release agent, or molybdenum sulfide may also be used as needed.

In an embodiment of the invention, the optical film may be formed on the carrier film in any mode. For example, they may be wound to form a continuous roll. For example, the continuous roll may be (1) a roll of an optical film laminate including a carrier film and a pressure-sensitive adhesive-carrying optical film formed on the carrier film. In this case, the system for manufacturing a liquid crystal display device has cutting means for cutting the optical film into sheet pieces of the optical film in such a manner that the optical film (carrying the pressure-sensitive adhesive) is cut at predetermined intervals, while the carrier film is left uncut (cutting means for performing half-cutting). For example, the cutting may be performed in such a manner as to classify non-defective and defective sheet pieces based on the result of an inspection performed using a defect inspection apparatus in the manufacturing system.

Alternatively, for example, the continuous roll may be (2) a roll of an optical film laminate including a carrier film and sheet pieces of pressure-sensitive adhesive-carrying optical film formed on the carrier film (a continuous roll of a so-called scored optical film).

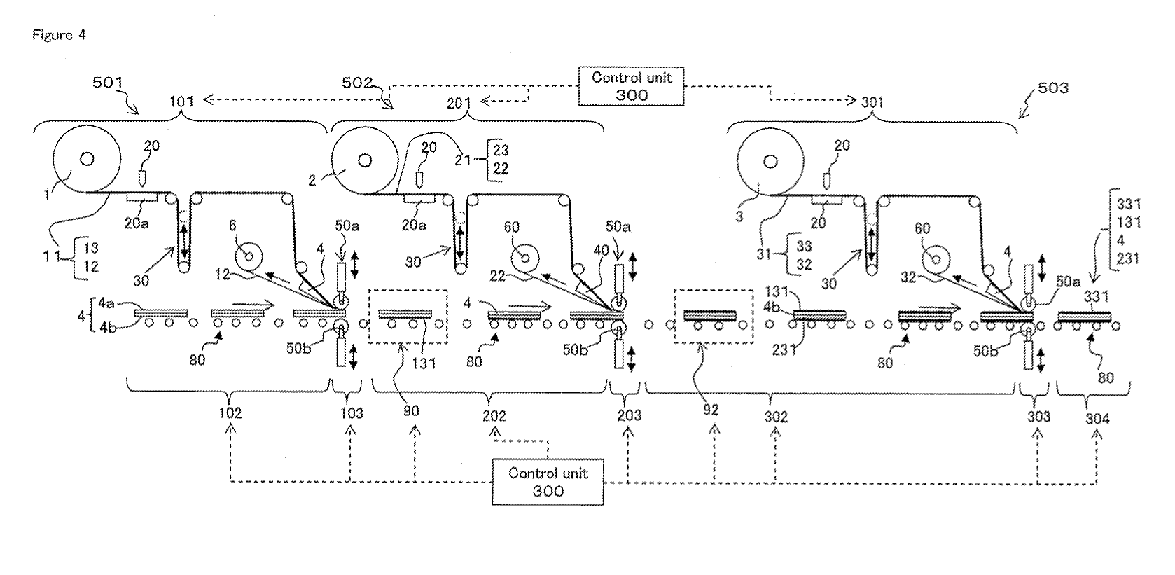

The liquid crystal display device includes a liquid crystal panel and at least a sheet piece or pieces of polarizing film provided on one or both sides of the liquid crystal panel, into which a driving circuit is incorporated as needed. The liquid crystal panel to be used may be of any type such as a vertical alignment (VA) type or an in-plane switching (IPS) type. The liquid crystal panel 4 shown in FIG. 4 has a structure including a pair of substrates (a backside substrate 4a and a viewer side substrate 4b) opposed to each other and a liquid crystal layer sealed in between the substrates.

### Embodiment 1

(Method for Manufacturing Liquid Crystal Display Device)

The liquid crystal display device manufacturing method includes: feeding long carrier films from continuous rolls, respectively, wherein the continuous rolls include rolls of laminates including the long carrier films and pressure-sensitive adhesive-carrying optical films each with a specific width placed on the carrier films; and bonding steps including bonding the optical films, which are peeled off or being peeled off from the carrier films, to first and second panel surfaces of a liquid crystal panel, respectively, wherein in the bonding steps, bonding the optical film to the first panel surface of the liquid crystal panel and bonding the optical film to the second panel surface of the liquid crystal panel are performed alternately.

The process until the bonding steps includes carrier film feeding steps including feeding the carrier films from the continuous rolls, respectively, and peeling steps including peeling off the optical films from the carrier films, respectively.

In the carrier film feeding steps, each optical film laminate (a laminated film including a carrier film and an optical film placed thereon) is drawn from each continuous roll and fed to the downstream side. During the feeding, the optical film is cut at specific intervals in the film widthwise direction perpendicular to the longitudinal direction, while the carrier film is left uncut, so that a sheet piece of the optical film is formed on the carrier film. When the continuous roll is a roll of the scored optical film, this cutting step is unnecessary. In the peeling steps, each carrier film is inwardly folded back at a front end part of a peeling unit so that a sheet piece of the optical film is peeled off from the carrier film and supplied to the bonding position in a bonding unit. The bonding steps include bonding, to the liquid crystal panel, sheet pieces of the optical films which are each peeled off or being peeled off in the peeling step. The carrier film feeding step, the peeling step, and the bonding step are continuously performed to bond a single sheet piece of the optical film to the liquid crystal panel. These steps can constitute one roll bonding process, and sheet pieces of the optical films can be bonded alternately to the first panel surface (viewer side) and second panel surface (back side) of the liquid crystal panel by a plurality of the roll bonding processes.

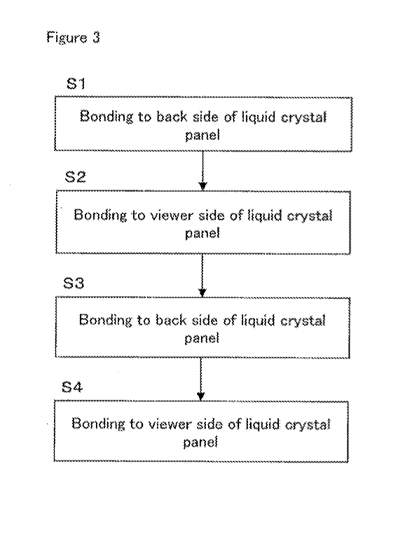

FIG. 3 shows an example with respect to the bonding order and the bonding direction in the bonding steps. It will be understood that the bonding order, the bonding direction, and the optical film types shown in FIG. 3 are not intended to limit embodiments of the invention. FIG. 3 shows a process including bonding an MD polarizing film to the back side of a liquid crystal panel (step S1), then bonding an MD polarizing film to the viewer side of the liquid crystal panel (step S2), and then bonding a reflective polarizing film to the back side of the liquid crystal panel (step S3). After the step S3, another optical film (such as an anti-glare-treated film) may be further bonded to the viewer side (step S4). The polarizing films may be bonded to the viewer and back sides of the liquid crystal panel so that their absorption axes are orthogonal to each other (crossed-Nicols). Bonding an MD polarizing film to the viewer side along the direction of the long side of the liquid crystal panel is non-limiting, and alternatively, it may be bonded along the direction of the short side, and correspondingly, an MD polarizing film may be bonded to the back side along the direction of the long side of the liquid crystal panel. The MD polarizing film is also non-limiting, and alternatively, a TD polarizing film may also be used.

### Other Embodiments

Another mode of the above embodiment may further include an inspection step including inspecting the optical film for defects (for example, by transmission inspection) before the cutting step for forming the sheet piece, in which cutting may be performed in such a manner that defects are avoided (called skip cutting) based on the result of the inspection step. Alternatively, the skip cutting may be performed while defect information previously attached to the optical film or the carrier film is read out.

(System for Manufacturing Liquid Crystal Display Device)

The liquid crystal display device manufacturing system is configured to feed long carrier films from continuous rolls, respectively, which include rolls of laminates including the long carrier films and pressure-sensitive adhesive-carrying optical films each with a specific width placed on the carrier films, and the liquid crystal display device manufacturing system has a bonding apparatus for bonding the optical films, which are peeled off or being peeled off from the carrier films, to first and second panel surfaces of a liquid crystal panel, respectively. The bonding apparatus includes a plurality of bonding units so that it alternately performs bonding the optical film to the first panel surface of the liquid crystal panel and bonding the optical film to the second panel surface of the liquid crystal panel. In the course to the plurality of bonding units, respectively, the liquid crystal display device manufacturing system also has carrier film feed units for feeding the carrier films from the continuous rolls, respectively, and peeling units for peeling off the optical films from the carrier films, respectively.

Hereinafter, the liquid crystal display device manufacturing system according to an embodiment of the invention is described with reference to FIG. 4. This manufacturing system includes a plurality of sheet piece lamination apparatuses each having a carrier film feed unit, a peeling unit, and a bonding unit. A first sheet piece lamination apparatus 501 is provided to laminate a sheet piece of an optical film to the back side of a liquid crystal panel along (parallel to) the direction of the short side of the liquid crystal panel. A second sheet piece lamination apparatus 502 is provided to laminate a sheet piece of an optical film to the viewer side of the liquid crystal panel along (parallel to) the direction of the long side of the liquid crystal panel. A third sheet piece lamination apparatus 503 is provided to laminate a sheet piece of an optical film to the sheet piece of the optical film, which has been laminated by the first sheet piece lamination apparatus, on the back side of the liquid crystal panel along (parallel to) the direction of the long side of the liquid crystal panel.

As shown in FIG. 4, the first sheet piece lamination apparatus 501 has a carrier film feed unit 101, a liquid crystal panel feed unit 102, a peeling unit 40, and a bonding unit 103 (including a bonding roller 50a and a driving roller 50b). The second sheet piece lamination apparatus 502 has a carrier film feed unit 201, a liquid crystal panel feed unit 202, a peeling unit 40, and a bonding unit 203 (including a bonding roller 50a and a driving roller 50b). The third sheet piece lamination apparatus 503 has a liquid crystal panel feed unit 302, a carrier film feed unit 301, a peeling unit 40, and a bonding unit 303 (including a bonding roller 50a and a driving roller 50b). In this embodiment, the liquid crystal panel feed unit 102 feeds a liquid crystal panel 4 in a direction parallel to the direction of the short side of the liquid crystal panel 4. A sheet piece 131 of a polarizing film is bonded to the back side 4a (the upper side in FIG. 4) of the liquid crystal panel 4 along the direction of the short side of the liquid crystal panel 4. Subsequently, the liquid crystal panel 4 with the sheet piece 131 bonded thereto is turned over and rotated by 90°. Subsequently, a sheet piece 231 of a polarizing film is bonded to the viewer side 4b (the upper side in FIG. 4) of the liquid crystal panel 4 along the direction of the long side of the liquid crystal panel 4. Subsequently, the liquid crystal panel 4 is turned over, and a sheet piece 331 of a reflective polarizing film is bonded to the back side 4a (the upper side in the drawing) of the liquid crystal panel 4 along the direction of the long side of the liquid crystal panel 4. It will be understood that this bonding method is non-limiting and that one or both of the sheet pieces of the polarizing films may be bonded to the liquid crystal panel from the lower side, and the sheet piece of the reflective polarizing film may be bonded to the liquid crystal panel from the lower side.

(Sheet Piece Lamination Apparatuses)

First, a description is given of the first sheet piece lamination apparatus 501. The liquid crystal panel feed unit 102 feeds the liquid crystal panel 4 to the bonding unit 103. In this embodiment, the liquid crystal panel feed unit 102 includes a feed roller 80, a suction plate, and other components. The liquid crystal panel 4 is fed to the downstream side of the manufacturing line by rotating the feed roller 80 or shifting the suction plate.

The carrier film feed unit 101 draws a long optical film laminate 11 from a continuous roll 1, wherein the laminate 11 includes a long carrier film 12 and a pressure-sensitive adhesive-carrying long polarizing film 13 placed thereon, and cuts the polarizing film 13 at predetermined intervals while leaving the carrier film 12 uncut, so that a sheet piece 131 of the polarizing film is formed on the carrier film 12. For the operation, the carrier film feed unit 101 has a cutting part 20, dancer rolls 30, and a take-up part 60.

The cutting part 20 holds the carrier film 12 by using a suction part 20a and cuts the polarizing film 13 at predetermined intervals, while leaving the carrier film 12 uncut, so that a sheet piece 131 of the polarizing film is formed on the carrier film 12. For example, the cutting part 20 may be a cutter, a laser, or the like.

The dancer rolls 30 have the function of maintaining tension on the carrier film 12. The carrier film feed unit 101 feeds the carrier film 12 via the dancer rolls 30.

The take-up part 60 takes up the carrier film 12 from which the sheet piece 131 is peeled off. The system may further include a feed roller between the bonding unit 103 and the take-up part 60.

The peeling unit 40 inwardly folds back the carrier film 12 at its front end part to peel off the sheet piece 131 (carrying the pressure-sensitive adhesive) of the polarizing film from the carrier film 12 and feeds the sheet piece 131 to the bonding position in the bonding unit 103. In this embodiment, a sharp knife edge part is used as a non-limiting example of the front end part of the peeling unit 40.

The bonding unit 103 bonds the sheet piece 131 of the polarizing film, which is peeled off by the peeling unit 40, to the back side (upper side) of the liquid crystal panel 4, which is supplied by the liquid crystal panel feed unit 102, with the pressure-sensitive adhesive interposed therebetween. In this embodiment, the bonding unit 103 includes a bonding roller 50a and a driving roller 50b.

The second sheet piece lamination apparatus 502 will be described briefly, because it includes the same components as the first sheet piece lamination apparatus 501 and each component represented by the same reference character has the same function.

The liquid crystal panel feed unit 202 feeds the liquid crystal panel 4 to the bonding unit 203. The liquid crystal panel feed unit 202 includes a turnover-rotation unit 90 having a turnover part for turning over the liquid crystal panel 4 and a rotation part for rotating it by 90°. The carrier film feed unit 201 draws and feeds a long optical film laminate 21 from a continuous roll 2, wherein the laminate 21 includes a long carrier film 22 and a pressure-sensitive adhesive-carrying long polarizing film 23 placed thereon. The cutting unit 20 holds the carrier film 22 by using a suction part 20a and cuts the polarizing film 23 at predetermined intervals, while leaving the carrier film 22 uncut, so that a sheet piece 231 of the polarizing film is formed on the carrier film 22. The peeling unit 40 inwardly folds back the carrier film 22 at its front end part to peel off the sheet piece 231 of the polarizing film (carrying the pressure-sensitive adhesive) from the carrier film 22, and feeds the sheet piece 231 to the bonding unit 203. The bonding unit 203 bonds the sheet piece 231 of the polarizing film, which is peeled off by the peeling unit 40, to the viewer side (upper side) of the liquid crystal panel 4, which is supplied by the liquid crystal panel feed unit 202, with the pressure-sensitive adhesive interposed therebetween.

The third sheet piece lamination apparatus 503 will be described briefly, because it includes the same components as the first sheet piece lamination apparatus 501 and each component represented by the same reference character has the same function. The third sheet piece lamination apparatus 503 is an apparatus for bonding a sheet piece 331 of a reflective polarizing film to the sheet piece 131 of the polarizing film placed on the back side of the liquid crystal panel 4.

The liquid crystal panel feed unit 302 feeds, to the bonding unit 303, the liquid crystal panel 4, to both sides of which the sheet pieces 131 and 231 have been bonded by the bonding units 103 and 203. The liquid crystal panel feed unit 302 includes a turnover part 92 for turning over the liquid crystal panel 4. The carrier film feed unit 301 draws a long optical film laminate 31 from a continuous roll 3 and feeds the laminate 31 to the downstream side, wherein the laminate 31 includes a carrier film 32 and a pressure-sensitive adhesive-carrying long reflective polarizing film 33 placed thereon. The cutting unit 20 holds the carrier film 32 by using a suction part 20a and cuts the reflective polarizing film 33 at predetermined intervals, while leaving the carrier film 32 uncut, so that a sheet piece 331 of the reflective polarizing film is formed on the carrier film 32. The peeling unit 40 inwardly folds back the carrier film 32 at its front end part to peel off the sheet piece 331 of the reflective polarizing film (carrying the pressure-sensitive adhesive) from the carrier film 32, and feeds the sheet piece 331 to the bonding unit 303. The bonding unit 303 bonds the sheet piece 331 of the reflective polarizing film, which is peeled off by the peeling unit 40, to the back side (upper side) of the liquid crystal panel 4, which is supplied by the liquid crystal panel feed unit 302, with the pressure-sensitive adhesive interposed therebetween. Specifically, the sheet piece 331 of the reflective polarizing film is bonded to the sheet piece 131 of the polarizing film.

(Control Unit)

A control unit 300 is provided to control the cutting part 20 and the carrier film feed units 101, 201, and 301 so that it controls the formation of the sheet pieces 131 and 231 of the polarizing films by cutting and the formation of the sheet piece 231 of the reflective polarizing film by cutting. The control unit 300 also controls the liquid crystal panel feed units 102, 202, 302, and 304, the turnover-rotation unit 90, the turnover part 92, and the bonding units 103, 203, and 303.

The liquid crystal panel feed unit 304 feeds the liquid crystal panel 4 (liquid crystal display device) to the downstream side, wherein the sheet pieces 131 and 231 of the polarizing films are bonded to both sides of the panel 4, and the sheet piece 331 of the reflective polarizing film is bonded to the back side of the panel 4.

For example, the timing of the operation of each unit and each apparatus is calculated by a detecting method using sensors placed at specific locations or by a method of detecting the rotating part of the feeder or the feeding mechanism with a rotary encoder or the like. The control unit 300 may be implemented in cooperation with software programs and hardware resources such as CPU and memories. In this case, program software, procedures, various settings, etc. are previously stored in memories. Private circuits, firmware, or the like may also be used for the implementation.

### Other Embodiments

In the above embodiments, bonding is performed first to the back side, second to the viewer side, and third to the back side. It will be understood that this process is non-limiting, and bonding may be further performed fourth to the viewer side. In addition, bonding first to the back side is non-limiting, and alternatively, bonding may be performed first to the viewer side.

### EXAMPLES

Different optical films were bonded to a liquid crystal panel (32 inch size) using the sheet piece lamination apparatuses shown in FIG. 4. The manufacturing system was configured to perform the turnover and 90° rotation of the liquid crystal panel appropriately depending on the optical film type and the bonding order. When long optical films are cut into sheet pieces, the sizes of the sheet pieces are determined depending on the bonding side and the bonding direction.

The optical films used were a MD polarizing film (SEG1423DU manufactured by NITTO DENKO CORPORATION), an anti-glare-treated AGS film (AGS1 (TDP1490) (product name), manufactured by Dai Nippon Printing Co., Ltd.), and a reflective polarizing film (DBEF manufactured by 3M Company). Table 1 shows the conditions concerning the optical films and the liquid crystal panel surface subjected to bonding (back side or viewer side) in Examples and Comparative Examples, respectively. In Table 1, sections (1) to (3) are each a feed section in which the liquid crystal panel is fed between the bonding processes, which are performed before and after the feeding. Section (4) is a feed section after the fourth bonding process. In Example 1 and Comparative Examples 1 and 2, four sheet piece lamination apparatuses were placed to perform the bonding processes, respectively. In Examples 2 and 3 and Comparative Examples 3 to 6, three sheet piece lamination apparatuses were placed to perform the bonding processes, respectively.

TABLE 1

| | Surface subjected to bonding | | | | | | | |
|---|---|---|---|---|---|---|---|---|
| | | Section | | Section | | Section | | Section |
| | First bonding | (1) | Second bonding | (2) | Third bonding | (3) | Fourth bonding | (4) |
| Example 1 | Bonding MD | → | Bonding MD | → | Bonding DBEF to | → | Bonding AGS | → |
| | polarizing film | | polarizing film | | back side | | film to viewer | |
| | to back side | | to viewer side | | | | side | |
| Example 2 | Bonding MD | → | Bonding MD | → | Bonding DBEF to | → | — | — |
| | polarizing film | | polarizing film | | back side | | | |
| | to back side | | to viewer side | | | | | |
| Example 3 | Bonding MD | → | Bonding MD | → | Bonding AGS | → | — | — |
| | polarizing film | | polarizing film | → | film to back | | | |
| | to back side | | to viewer side | | side | | | |
| Comparative | Bonding MD | → | Bonding AGS film | → | Bonding MD | → | Bonding DBEF | → |
| Example 1 | polarizing film | | to viewer side | | polarizing film | | to back side | |
| | to viewer side | | | | to back side | | | |
| Comparative | Bonding MD | → | Bonding MD | → | Bonding AGS | → | Bonding DBEF | → |
| Example 2 | polarizing film | | polarizing film | | film to viewer | | to back side | |
| | to back side | | to viewer side | | side | | | |
| Comparative | Bonding MD | → | Bonding DBEF to | → | Bonding MD | → | — | — |
| Example 3 | polarizing film | | back side | | polarizing film | | | |
| | to back side | | | | to viewer side | | | |
| Comparative | Bonding MD | → | Bonding AGS film | → | Bonding MD | → | — | — |
| Example 4 | polarizing film | | to back side | | polarizing film | | | |
| | to back side | | | | to viewer side | | | |
| Comparative | Bonding MD | → | Bonding MD | → | Bonding AGS | → | — | — |
| Example 5 | polarizing film | | polarizing film | | film to back | | | |
| | to viewer side | | to back side | | side | | | |
| Comparative | Bonding MD | → | Bonding AGS film | → | Bonding MD | → | — | — |
| Example 6 | polarizing film | | to viewer side | | polarizing film | | | |
| | to viewer side | | | | to back side | | | |

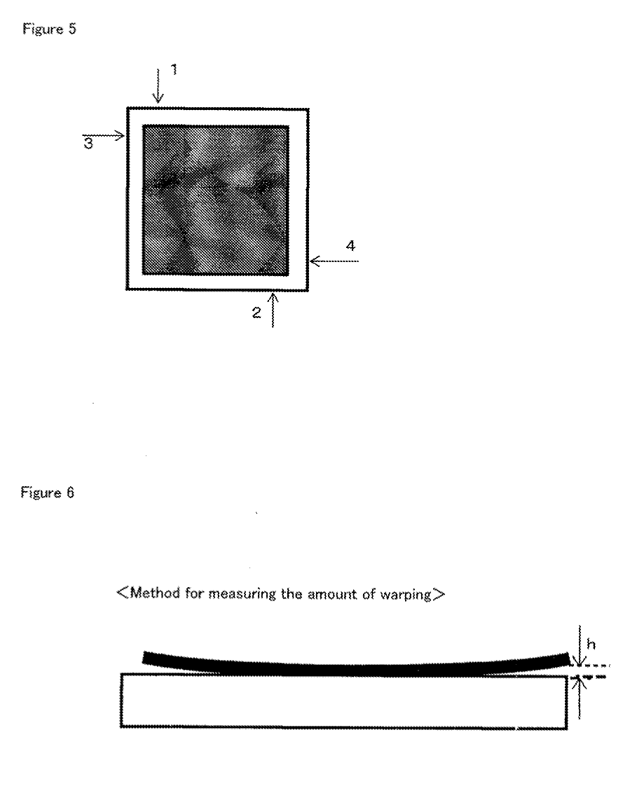

Table 2 shows the evaluation of the direction and amount of warping of the liquid crystal panel, bonding misalignment, panel misalignment, and cullet defects. FIG. 6 illustrates the method for measuring the amount of warping. After the bonding of the optical films, the liquid crystal panel is placed on a surface plate in such a manner that the center of the panel comes into contact with the plate (so placed that it is concave to the upper side). The height from the level of the panel center to the level of the end where the warping is the maximum is determined as the amount of warping, and the average value of 100 liquid crystal panels is shown in Table 2. The state of the deformation on the viewer side is indicated by “concave” or “convex.”

FIG. 5 illustrates the method for measuring the amount of bonding misalignment. The amount of bonding misalignment was determined by a process including: measuring the amount (absolute value) of deviation of the bonded optical film from the reference position (for example, the end of the black matrix) at four points (Nos. 1 to 4) in each section; and determining the maximum value as the amount of bonding misalignment. Table 2 shows the average of the values obtained using 100 liquid crystal panels. This bonding misalignment is caused by the fact that when the warped panel is subjected to the bonding process, the end of the panel lifted by the warping unevenly comes into contact with the bonding roller so that the panel is misaligned during the nipping between a pair of bonding rollers. Table 2 also shows the rate (%) of defective panels caused by cullet foreign particles and the amount of panel misalignment at the bonding position. The amount of panel misalignment was determined by a process including measuring the maximum amount of deviation from the reference position in each section during the alignment of the panel and calculating the average value of 100 pieces. The panel misalignment is caused by the fact that the liquid crystal panel being fed is so warped to be made unstable.

TABLE 2

| | Amount [mm] of warping after each | | | | Amount [mm] of bonding | | | | Rate (%) | |
|---|---|---|---|---|---|---|---|---|---|---|
| | bonding process | | | | misalignment | | | | of | Amount [mm] |
| | Section | Section | Section | Section | Section | Section | Section | Section | defective | of panel |
| | (1) | (2) | (3) | (4) | (1) | (2) | (3) | (4) | panels | misalignment |
| Example 1 | 1.5 | 0.8 | 1.2 | 0.9 | 0.3 | 0.1 | 0.2 | 0.2 | 1 | 0.1 |
| | (convex) | (concave) | (convex) | (concave) | | | | | | |
| Example 2 | 1.5 | 0.8 | 1.2 | — | 0.3 | 0.1 | 0.2 | — | 1 | 0.1 |
| | (convex) | (concave) | (convex) | | | | | | | |
| Example 3 | 1.5 | 0.8 | 1.2 | — | 0.3 | 0.1 | 0.2 | — | 1 | 0.1 |
| | (convex) | (concave) | (convex) | | | | | | | |
| Comparative | 1.5 | 2.5 | 1.1 | 0.5 | 0.3 | 0.9 | 0.2 | 0.1 | 2 | 2.1 |
| Example 1 | (concave) | (concave) | (concave) | (concave) | | | | | | |
| Comparative | 1.5 | 0.8 | 2.7 | 1.7 | 0.3 | 0.1 | 1.1 | 0.3 | 2 | 2.3 |
| Example 2 | (convex) | (concave) | (convex) | (convex) | | | | | | |
| Comparative | 1.5 | 2.5 | 1.6 | — | 0.3 | 1.0 | 0.3 | — | 7 | 0.4 |
| Example 3 | (convex) | (convex) | (convex) | | | | | | | |
| Comparative | 1.5 | 2.2 | 1.4 | — | 0.3 | 0.9 | 0.2 | — | 6 | 0.3 |
| Example 4 | (convex) | (convex) | (convex) | | | | | | | |
| Comparative | 1.5 | 0.8 | 2.0 | — | 0.3 | 0.1 | 0.8 | — | 5 | 0.1 |
| Example 5 | (concave) | (convex) | (convex) | | | | | | | |
| Comparative | 1.4 | 2.5 | 1.5 | — | 0.3 | 1.0 | 0.3 | — | 1 | 2.2 |
| Example 6 | (concave) | (concave) | (concave) | | | | | | | |

In Examples 1 to 3 where the bonding processes are performed alternately, the amount of warping is kept at low level in all of sections (1) to (4). In Comparative Examples 1 to 6 where boding processes were successively performed on the same panel surface, however, a large amount of warping was produced in the section immediately after bonding was continuously repeated on the same panel surface. As a result, it was demonstrated that all of the amount of bonding misalignment, the rate of defective panels, and the amount of panel misalignment were successfully kept smaller in Examples 1 to 3 than in Comparative Examples 1 to 6.

What is claimed is:

1. A method for manufacturing a liquid crystal display device, comprising:
feeding long carrier films from continuous rolls, respectively, wherein the continuous rolls comprise rolls of laminates comprising the long carrier films and pressure-sensitive adhesive-carrying optical films each with a specific width placed on the carrier films; and
bonding steps comprising bonding the optical films, which are peeled off or being peeled off from the carrier films, to first and second panel surfaces of a liquid crystal panel, respectively, wherein
in the bonding steps, bonding the optical film to the first panel surface of the liquid crystal panel and bonding the optical film to the second panel surface of the liquid crystal panel are performed alternately.

2. A system for manufacturing a liquid crystal display device,
which is configured to feed long carrier films from continuous rolls, respectively, wherein the continuous rolls comprise rolls of laminates comprising the long carrier films and pressure-sensitive adhesive-carrying optical films each with a specific width placed on the carrier films, and
which comprises a bonding apparatus for bonding the optical films, which are peeled off or being peeled off from the carrier films, to first and second panel surfaces of a liquid crystal panel, respectively, wherein
the bonding apparatus comprises a plurality of bonding units so that it alternately performs bonding the optical film to the first panel surface of the liquid crystal panel and bonding the optical film to the second panel surface of the liquid crystal panel.
